(19) United States
(12) Patent Application Publication
(10) Pub. No.: US 2022/0231548 A1
(43) Pub. Date: Jul. 21, 2022

(54) LAMINATED IRON CORE AND MANUFACTURING METHOD THEREFOR

(71) Applicant: Siemens Aktiengesellschaft, Muenchen (DE)

(72) Inventors: Chang Peng LI, Beijing (CN); Qing Qing ZHANG, Shanghai (CN); Guo Feng CHEN, Beijing (CN); Kateryna SVYNARENKO, Shanghai (CN)

(73) Assignee: Siemens Aktiengesellschaft, Muenchen (DE)

(21) Appl. No.: 17/605,274

(22) PCT Filed: Apr. 30, 2019
(86) PCT No.: PCT/CN2019/085123

§ 371 Date: Oct. 21, 2021

(51) Int. Cl. H02K 1/02; H02K 15/02; B22F 10/28; B22F 10/73; B22F 12/41; B22F 12/49; B22F 12/70; B33Y 10/00; B33Y 70/00; B33Y 80/00

(52) U.S. Cl. CPC H02K 1/02; H02K 15/02; B22F 10/28; B22F 10/73; B22F 12/41; B22F 12/49; B22F 2302/20; B33Y 10/00; B33Y 70/00; B33Y 80/00; B22F 2201/02; B22F 2201/11; B22F 2301/35; B22F 12/70

(57) ABSTRACT

A manufacturing method is performed in an additive manufacturing printing apparatus. An embodiment of the manufacturing method includes: S1—feeding inert gas into the additive manufacturing printing apparatus, and performing laser scanning on silicon steel metal particles to start to melt the silicon steel metal particles from bottom to top layer by layer into a silicon steel metal layer; S2—feeding treatment gas into the additive manufacturing printing apparatus, performing laser scanning on the silicon steel particles again to enable the treatment gas to react with the molten silicon steel metal particles to finally form an insulating nitride layer, and alternately performing S1 and S2 until the laminated iron core of a structure having a plurality of alternate silicon steel metal layers and insulating nitride layers is formed. An embodiment of the present invention may manufacture a customized laminated iron core with a complex shape and good performance.

### PRIORITY STATEMENT

This application is the national phase under 35 U.S.C. § 371 of PCT International Application No. PCT/CN2019/085123 which has an International filing date of Apr. 30 2019, which designated the United States of America 2020, the entire contents of which are hereby incorporated herein by reference.

### FIELD

Embodiments of the present invention generally relate to the field of additive manufacturing, and more particularly, to a laminated iron core and a manufacturing method therefor.

### BACKGROUND

For electronic products such as electric motors and power transformers, a copper wire is usually wound on a ferromagnetic component, and has a high magnetic conductivity relative to air to increase a magnetic flux to achieve high strength and efficiency.

As shown in FIG. 1, in order to reduce eddy current losses caused by a fluctuating magnetic field, a laminated iron core 10 is formed by stacking silicon steel sheets covered with insulating films, and is usually applied to the power transformers and the electric motors. The insulating films serve as barriers for an eddy current, so that the eddy current flows only in a finite closed loop, that is, flows in the lamination thickness of each layer in FIG. 1. The arrow in FIG. 1 indicates a direction C₁ of flowing of the eddy current, and an arrow S₁ perpendicular to the direction C₁ of the eddy current indicates a direction of a magnetic field. FIG. 1 also shows a block-shaped iron core 20 which does not have a sheet stacked structure of the laminated iron core and has an eddy current also limited to the closed loop. The direction of the eddy current is indicated by a direction C₂, and an arrow S₂ perpendicular to the direction C₂ of the eddy current indicates a direction of a magnetic field. Particularly, the lamination thickness of each layer of the laminated iron core 10 is approximately 0.3 mm. The current of one eddy current closed loop is proportional to the area of the closed loop, so that most leakage currents may be prevented to reduce the eddy current to a very small level. Generally, higher working frequency indicates a smaller lamination thickness of a single layer of the laminated iron core 10.

In order to manufacture a layer-by-layer stacked structure of the laminated iron core 10 as shown in FIG. 1, a silicon steel thin layer is first extruded into a predetermined thin layer shape and then is assembled according to the stacked structure, which not only has a higher requirement for manufacturing of a silicon steel thin layer structure, but also leads to very complex assembling of the stacked structure of the entire laminated iron core 10, therefore, in order to achieve optimal performance and component miniaturization, the manufacturing of laminated iron cores is more complex, and this becomes the biggest problem and limitation to the manufacturing of the laminated iron cores.

Additive manufacturing is now one of the fastest-growing advanced manufacturing techniques in the world, and shows a broad application prospect. A selective laser melting (SLM) process, one of the additive manufacturing techniques, may quickly manufacture parts which are the same as a CAD model through a selective laser melting mode. At present, the SLM process has been widely used. Different from traditional material removal mechanisms, the additive manufacturing is based on a completely opposite material incremental manufacturing philosophy. The SLM uses high-power lasers to melt metal powder and manufactures parts/components layer by layer through 3D CAD inputting, so that components having complex internal channels may be successfully manufactured. The additive manufacturing techniques may provide a unique potential for random manufacturing of complex structural components that are often not easily manufactured through conventional processes.

The additive manufacturing techniques are also used to manufacture iron cores of customized and complex shapes to optimize magnetic properties and achieve component miniaturization. However, the current additive manufacturing techniques may only be used to manufacture block-shaped magnetic cores with eddy current losses. The eddy current losses reduce component power, and heat generated by the eddy current may significantly deteriorate the component performance and also impede size miniaturization of a system.

### SUMMARY

At least one embodiment of the present invention provides a manufacturing method for a laminated iron core. The manufacturing method is performed in an additive manufacturing printing apparatus, and includes:

S1 feeding inert gas into the additive manufacturing printing apparatus, and performing laser scanning on silicon steel metal particles to start to melt the silicon steel metal particles from bottom to top layer by layer into a silicon steel metal layer; and

S2 feeding treatment gas into the additive manufacturing printing apparatus, performing laser scanning on the silicon steel particles again to enable the treatment gas to react with the molten silicon steel metal particles to finally form an insulating nitride layer, and

alternately performing the steps S1 and S2 till the laminated iron core of a structure having a plurality of alternate silicon steel metal layers and insulating nitride layers is formed.

A second embodiment of the present invention provides a laminated iron core. The laminated iron core is manufactured by using at least one embodiment of the manufacturing method for the laminated iron core according to the first embodiment.

### BRIEF DESCRIPTION OF THE DRAWINGS

FIG. 1 is a contrast diagram of structures and eddy currents of a laminated iron core and a block-shaped iron core;

FIG. 2 is a schematic diagram of a selective laser melting device;

FIG. 3 is a cross-sectional structural schematic diagram of a laminated iron core manufactured by using a specific embodiment of the present invention;

FIG. 4 is a performance comparison diagram of different iron-nitrogen alloys;

FIG. 5 is a schematic diagram of parallel printing of an additive manufacturing technique; and

FIG. 6 is a cross-sectional diagram of crystalline grains of a silicon steel metal layer.

### DETAILED DESCRIPTION OF THE EXAMPLE EMBODIMENTS

At least one embodiment of the present invention provides a manufacturing method for a laminated iron core. The manufacturing method is performed in an additive manufacturing printing apparatus, and includes:

S1 feeding inert gas into the additive manufacturing printing apparatus, and performing laser scanning on silicon steel metal particles to start to melt the silicon steel metal particles from bottom to top layer by layer into a silicon steel metal layer; and

S2 feeding treatment gas into the additive manufacturing printing apparatus, performing laser scanning on the silicon steel particles again to enable the treatment gas to react with the molten silicon steel metal particles to finally form an insulating nitride layer, and

alternately performing the steps S1 and S2 till the laminated iron core of a structure having a plurality of alternate silicon steel metal layers and insulating nitride layers is formed.

Further, in an embodiment, the inert gas may be argon, and the treatment gas may be nitrogen.

Further, in an embodiment, the step S1 further includes the following step: performing the laser scanning by adopting parallel printing, where the parallel printing laser scanning is performed along an X direction to obtain a crystalline grain direction in a Y direction, or the parallel printing laser scanning is performed along a Y direction to obtain a crystalline grain direction in an X direction. The crystalline grain direction is an easy magnetization direction.

Further, in an embodiment, a laser power of the laser scanning is 200 to 1000 W, and a scanning speed of the laser scanning is 500 to 1500 mm/s.

Further, in an embodiment, a thickness of each of the nitride layers ranges from 20 microns to 40 microns.

Further, in an embodiment, a ratio of the inert gas to the treatment gas ranges from 2 to 5.

Further, in an embodiment, the manufacturing method for the laminated iron core further includes the following step: conveying the silicon steel metal particles from a forming cylinder of the additive manufacturing printing apparatus into a recycling cylinder for recycling.

Further, in an embodiment, the additive manufacturing printing apparatus is a selective laser melting device.

A second embodiment of the present invention provides a laminated iron core. The laminated iron core is manufactured by using at least one embodiment of the manufacturing method for the laminated iron core according to the first embodiment.

An embodiment of the present invention may provide an integrated laminated iron core which does not need any assembling between silicon steel metal layers and insulating nitride layers of a laminated iron core. Furthermore, an embodiment of the present invention may further adjust a magnetic conducting direction and a magnetization degree as well as the performance of the laminated iron core by adjusting manufacturing parameters and a printing policy. Furthermore, the insulating nitride layers of an embodiment of the present invention are also magnetically conductive, and thus have little impact on the performance of the laminated iron core. In an embodiment of the present invention, the insulating nitride layers are formed by a nitriding step, and finally a laminated structure is formed, thereby avoiding or reducing eddy current losses. An embodiment of the present invention may easily control the thicknesses of a single silicon steel metal layer and a single insulating nitride layer. An embodiment of the present invention may manufacture a customized laminated iron core with a complex shape and good performance according to a requirement by virtue of the additive manufacturing technique, and may obtain a crystalline grain direction orientation with higher magnetic conductivity and improve the performance of the iron core by adjusting a scanning policy. Metal powder of an embodiment of the present invention may be recycled.

Specific implementations of the embodiments of present invention are described below in reference to accompanying drawings.

An embodiment of the present invention provides a mechanism for manufacturing a laminated iron core by using an additive manufacturing technique. By adopting a manufacturing process of the additive manufacturing technique, the laminated iron core is integrated and does not need any middle assembling procedures.

An embodiment of the present invention is preferably implemented in a selective laser melting device. The selective laser melting device is one of additive manufacturing apparatuses.

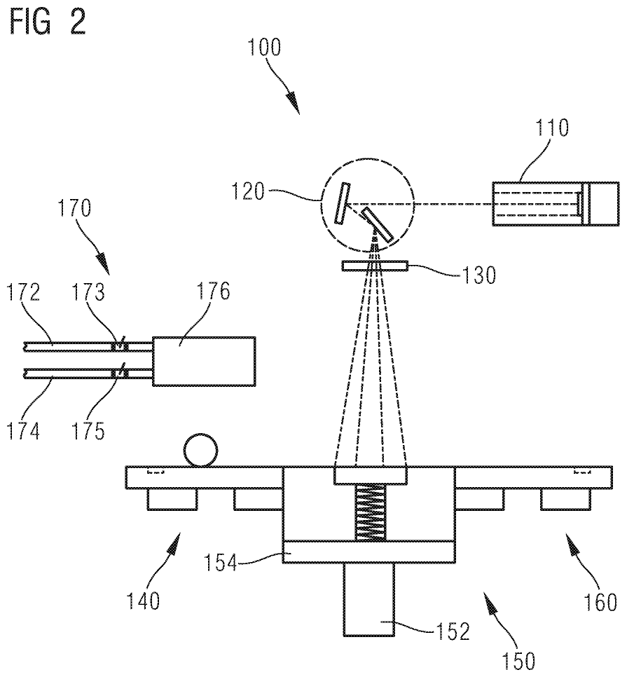

FIG. 2 is a schematic diagram of a selective laser melting device. As shown in FIG. 2, the selective laser melting device 100 includes a laser source 110, a mirror scanner 120, a prism 130, a powder conveying cylinder 140, a forming cylinder 150, and a recycling cylinder 160. The laser source 110 is arranged above the selective laser melting device 100 and serves as a heating source for metal powder. That is, the laser source 110 is used for melting the metal powder for 3D printing.

A lower part of the powder conveying cylinder 140 is provided with a first piston (not shown) capable of moving up and down. Standby metal powder is placed in a chamber space, located above the first piston, of the powder conveying cylinder 140, and is conveyed into the forming cylinder 150 from the powder conveying cylinder 140 along with up-down movement of the first piston. A 3D printing piece placing table 154 is arranged in the forming cylinder 150. A 3D printing piece C is clamped above the placing table 154. A second piston 152 is fixed below the placing table 154. The second piston 152 and the placing table 154 are perpendicularly arranged. In a 3D printing process, the second piston 152 moves from top to bottom to form a printing space in the forming cylinder 150. The laser source 110 for laser scanning should be arranged above the forming cylinder 150 of the selective laser melting device. The mirror scanner 120 adjusts positions of lasers by adjusting an angle of the prism 130, and the metal powder in a certain area is determined to be subjected to the laser melting via the adjustment of the prism 130. The powder conveying cylinder 140 further includes a roller (not shown). The metal powder P is stacked on an upper surface of the first piston, and the first piston moves perpendicularly from bottom to top to convey the metal powder to an upper part of the powder conveying cylinder 140. The roller may roll on the metal powder P to convey the metal powder P into the forming cylinder 150, thereby continuously performing the laser scanning on the metal powder to decompose the metal powder into powder matrixes. The laser scanning is continuously performed on the powder matrixes till the powder matrixes are sintered from bottom to top into the printing piece C of a preset shape.

The selective laser melting device 100 further includes a gas supply apparatus 170. The gas supply apparatus 170 includes a first gas inlet pipeline 172, a second gas inlet pipeline 174, and a gas outlet pipeline 176. A first valve 173 is also arranged on the first gas inlet pipeline 172, and a second valve 175 is arranged on the second gas inlet pipeline 174. A control apparatus 171 is connected to the first valve 173 and the second valve 175 and is used for controlling opening and closing of the first gas inlet pipeline 172 and the second gas inlet pipeline 174.

A first embodiment of the present invention provides a manufacturing method for a laminated iron core. The manufacturing method includes the following steps.

First, step S1 is performed: Inert gas is fed into an additive manufacturing printing apparatus to perform laser scanning on silicon steel metal particles to start to sinter the silicon steel metal particles from bottom to top layer by layer into a silicon steel metal layer, where the silicon steel metal particles are iron-silicon alloys, and 1 to 6 percent of silicon is added to reduce electrical conductivity of iron, and the inert gas includes nitrogen or argon; and

Then step S2 is performed: Treatment gas is fed into the additive manufacturing printing apparatus to perform laser scanning on the silicon steel particles again to enable the treatment gas to react with the molten silicon steel metal particles to finally form an insulating nitride layer, where the thickness of the insulating nitride layer may be determined by adjusting the thickness of a powder laying layer.

The steps S1 and S2 are alternately performed till the laminated iron core of a structure having a plurality of alternate silicon steel metal layers and insulating nitride layers is formed.

Generally, in 3D printing, a laser melting and sintering process is implemented in an environment with inert gas such as nitrogen and argon, so as to avoid possible oxidization. The inert gas is argon, and the treatment gas is nitrogen. Therefore, in this embodiment, the inert gas is to protect the silicon steel metal layers from being oxidized in a forming process, and the treatment gas is to enable the silicon steel metal layers to be ammonified to form the insulating nitride layers.

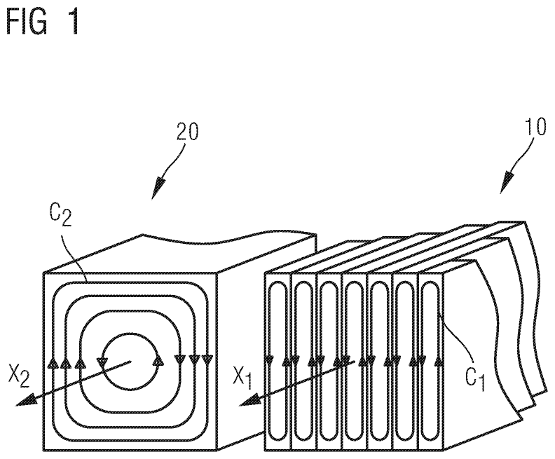

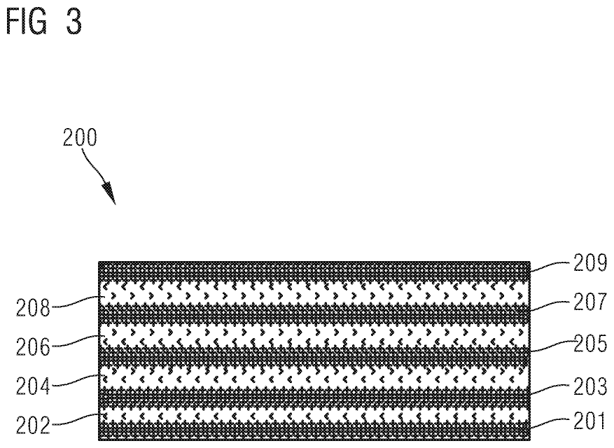

Specifically, the steps S1 and S2 are alternately performed to form a laminated iron core 200 as shown in FIG. 3. As shown in FIG. 3, the step S1 is performed first: The argon is fed into the selective laser melting device 100; during the laser scanning, the first valve 173 of the first gas inlet pipeline 172 is opened to convey the inert gas into the selective laser melting device 100, and at the same time, the second valve 175 of the second gas inlet pipeline 174 is closed to cut off supplying of ammonia NH3 serving as the treatment gas into the selective laser melting device 100, thereby forming a gas environment for the laser scanning; and the laser scanning is continuously performed on the silicon steel metal powder to decompose the metal powder into the powder matrixes, and the laser scanning is continuously performed on the silicon steel powder matrixes till the powder matrixes are sintered from bottom to top layer by layer into a first silicon steel metal layer 201. The step S2 is then performed, as shown in FIG. 1: The first gas inlet pipeline 172 is used for conveying the inert gas, and the second gas inlet pipeline 174 is used for conveying the treatment gas; the first valve 173 of the first gas inlet pipeline 172 is closed to cut off supplying of the inert gas into the selective laser melting device 100; the second valve 175 of the second gas inlet pipeline 174 is opened to allow the ammonia NH3 serving as the treatment gas to enter the selective laser melting device 100; the ammonia NH3 adjacent to the forming cylinder 150 may be decomposed into ions and react with a silicon steel metal material; and the ions decomposed from the ammonia NH3 are diffused to generate a thin first insulating nitride layer 202 together with a metal material of the printing piece. When a silicon steel material is a target of 3D printing, the nitrogen, close to a laser scanning path, in an area subjected to the laser scanning at each time is decomposed under action of the temperature in the 3D printing process, and reacts with the silicon steel metal material to form the insulating nitride layer. By analogy, the steps S1 and S2 are repeatedly performed to form the first silicon steel metal layer 201, the first insulating nitride layer 202, a second silicon steel metal layer 203, a second insulating nitride layer 204, a third silicon steel metal layer 205, a third insulating nitride layer 206, a fourth silicon steel metal layer 207, a fourth insulating nitride layer 208, and a fifth silicon steel metal layer 209, which are as shown in FIG. 3, from bottom to top in sequence.

It should be noted that the laminated iron core 200 is only an example. Specific numbers of the silicon steel metal layers and insulating nitride layers are not limited thereto as long as one silicon steel metal layer and one insulating nitride layer are alternately arranged. Specific situations may be adjusted according to specific application scenarios and process requirements.

Specifically, Fe ions in silicon steel and N ions in the nitrogen may have different compounds. The present invention proportions the inert gas and the treatment gas according to different requirements, and different compounds have different insulating properties and magnetic conductivities. The extremely stable ammonia is decomposed into N ions and H ions only under action of high temperature of the laser scanning, so that ammonia may only form amides along a scanning path. Specifically, the following chemical reaction equations may occur in nitridation reaction of the step S₂:

4Fe+½N₂→Fe₄N;

3Fe+½N₂→Fe₃N;

2Fe+½N₂→Fe₂N.

Therefore, the insulating nitride layers are iron nitrides, including, but not limited to, the above-mentioned iron nitrides. It is most desirable to obtain a Fe₄N compound, and Fe₃N is also acceptable, but Fe₂N or FeN is not satisfactory.

Further, a laser power of the laser scanning is 200 to 1000 W, and a scanning speed of the laser scanning is 500 to 1500 mm/s. Therefore, different iron-nitrogen alloys may be obtained by adjusting a partial pressure of the nitrogen, a flow rate of the nitrogen, a scanning temperature, and the scanning speed according to different application scenarios, and different magnetic conductivities may be obtained by adjusting proportions of the different iron-nitrogen alloys.

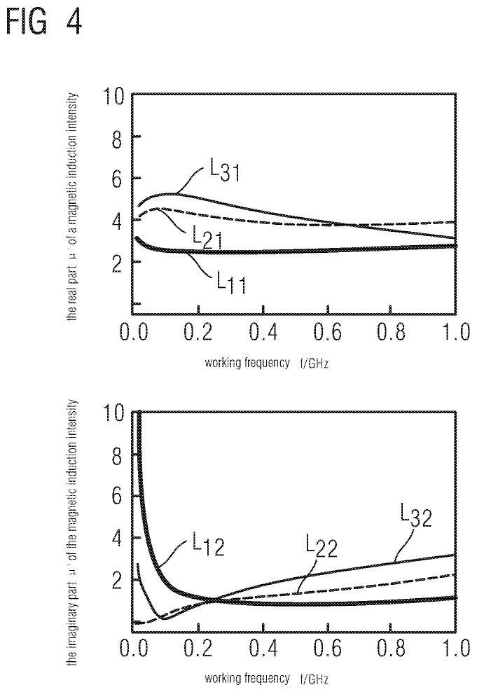

FIG. 4 is a performance comparison diagram of different iron-nitrogen alloys. A vertical coordinate of an upper figure is a real part μ′ of a magnetic induction intensity, a vertical coordinate of a lower figure is an imaginary part μ′ of the magnetic induction intensity, and horizontal coordinates of the upper figure and the lower figure indicate a working frequency (f/GHz). A line L₁ represents Fe₃N, a line L₂ represents Fe₄N, and a line L₃ represents ferrite. As shown in the figure, the real part of the magnetic induction material reflects a magnetization degree of the material, and the magnetization degree of Fe₄N is greater than that of Fe₃N, and the higher the real part of the magnetic induction intensity the better, which represents a driving force. The imaginary part of the magnetic induction intensity reflects a magnetic loss degree of the material, which is related to the working efficiency, and the lower the imaginary part of the magnetic induction intensity the better, which represents the magnetic loss. Therefore, referring to FIG. 4, it can be known that Fe₄N is the best iron-nitrogen alloy.

Further, the thickness of the nitride layer ranges from 20 microns to 40 microns.

In order to obtain the insulating nitride layers with predetermined thicknesses, a ratio of the inert gas to the treatment gas ranges from 2 to 5. The thicknesses of the insulating nitride layers are accurately determined by the ratio of the inert gas to the treatment gas, and the nitride layers having the thicknesses of approximately 20 microns may serve as insulating barrier layers to avoid eddy current losses.

It should be noted that although the steps S1 and S2 provided by an embodiment of the present invention are alternately performed, one silicon steel metal layer may be formed according to once printing of the silicon steel metal powder, and a plurality of silicon steel metal layers may be formed by adding a plurality of times of silicon steel metal powder printing without setting the insulating nitride layers.

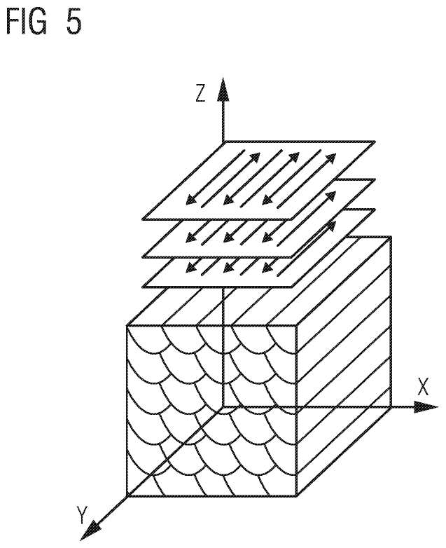

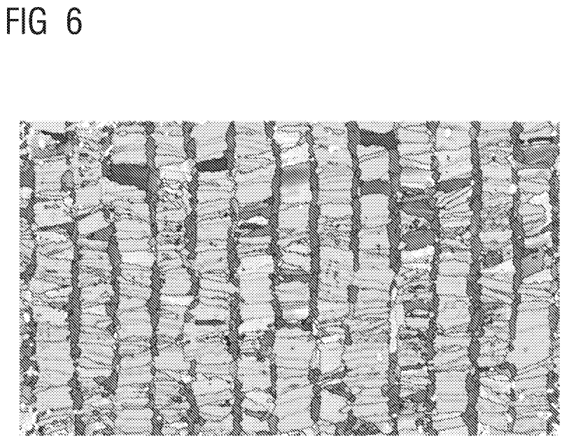

According to a preferable embodiment of the present invention, the step S1 further includes the following steps performing the laser scanning by adopting parallel printing, where the parallel printing laser scanning is performed along an X direction to obtain a crystalline grain direction in a Y direction, or the parallel printing laser scanning is performed along a Y direction to obtain a crystalline grain direction in an X direction. The crystalline grain direction is a magnetization direction. FIG. 5 is a schematic diagram of parallel printing of an additive manufacturing technique. As shown in FIG. 5, a Z direction in the figure is a direction where various material layers are formed from bottom to top. A parallel printing direction is perpendicular to a direction where the crystalline grains in the silicon steel metal layers are formed. Therefore, the parallel printing is performed along the X direction, and a temperature gradient is along the Y direction. Then, as shown in FIG. 6, the crystalline grain direction is also along the Y direction, and the magnetization direction is also along the Y direction. Therefore, the present invention may adjust the crystalline grain direction through the printing policy and select a specific direction to realize magnetic conduction and magnetization. The present invention may adjust the magnetic conducting direction and the magnetization degree by adjusting the crystalline grain direction. If it is not desired that the crystalline grains are anisotropic, a 90-degree or 60-degree rotary printing and scanning policy may be adopted.

An embodiment of the present invention may provide an integrated laminated iron core which does not need any assembling between silicon steel metal layers and insulating nitride layers of a laminated iron core. Furthermore, an embodiment of the present invention further may adjust the magnetic conducting direction and the magnetization degree as well as the performance of the laminated iron core by adjusting manufacturing parameters and a printing policy. Furthermore, the insulating nitride layers of an embodiment of the present invention are also magnetically conductive, and thus have little impact on the performance of the laminated iron core. In an embodiment of the present invention, the insulating nitride layers are formed by a nitriding step, and finally a laminated structure is formed, thereby avoiding or reducing the eddy current losses. An embodiment of the present invention may easily control the thicknesses of the single silicon steel metal layer and insulating nitride layer. An embodiment of the present invention may manufacture the customized laminated iron core with a complex shape and good performance according to a requirement by virtue of the additive manufacturing technique, and may obtain a crystalline grain direction orientation with higher magnetic conductivity and improve the performance of the iron core by adjusting a scanning policy. Metal powder of an embodiment of the present invention may be recycled.

Although the content of the present invention has been described in detail with reference to the foregoing preferred embodiments, it should be noted that the foregoing descriptions should not be considered as a limitation to the present invention. Various modifications and replacements to the present invention will be apparent to persons skilled in the art after they read the foregoing content. Therefore, the protection scope of the present invention should be subject to the appended claims. In addition, any reference numeral in the claims should not be considered as a limitation to the present invention. The term “comprise”, “include”, and variants thereof do not exclude other apparatuses or steps that are not listed in the claims or specification. The terms such as “first” and “second” are merely used for representing names but do not represent any particular order.

1. A manufacturing method for a laminated iron core, the manufacturing method being performed in an additive manufacturing printing apparatus and comprising:
S1 feeding inert gas into the additive manufacturing printing apparatus, and performing laser scanning on silicon steel metal particles to melt the silicon steel metal particles from a relatively bottom to a relatively top, layer by layer, to form a silicon steel metal layer; and
S2 feeding treatment gas into the additive manufacturing printing apparatus, and performing laser scanning on the silicon steel metal particles again to enable the treatment gas to react with molten silicon steel metal particles, to form an insulating nitride layer; and
alternately performing the S1 and S2 to form the laminated iron core of a structure having a plurality of alternate silicon steel metal layers and insulating nitride layers.

2. The method of claim 1, wherein the inert gas is argon, and wherein the treatment gas is nitrogen.

3. The method of claim 2, wherein the S1 further comprises:
performing the laser scanning by adopting parallel printing, wherein parallel printing laser scanning is performed along an X direction to obtain a crystalline grain direction in a Y direction, or wherein the parallel printing laser scanning is performed along a Y direction to obtain a crystalline grain direction in an X direction; and wherein the crystalline grain direction is an easy magnetization direction.

4. The method of claim 2, wherein a laser power of the laser scanning is 200 to 1000 W, and wherein a scanning speed of the laser scanning is 500 to 1500 mm/s.

5. The method of claim 1, wherein a thickness of the insulating nitride layer ranges from 20 microns to 40 microns.

6. The method of claim 1, wherein a ratio of the inert gas to the treatment gas ranges from 2 to 5.

7. The method of claim 1, further comprising:
conveying the silicon steel metal particles from a forming cylinder of the additive manufacturing printing apparatus into a recycling cylinder for recycling.

8. The method of claim 1, wherein the additive manufacturing printing apparatus is a selective laser melting device.

9. A laminated iron core, wherein the laminated iron core is manufactured by at least:
S1 feeding inert gas into an additive manufacturing printing apparatus, and performing laser scanning on silicon steel metal particles to melt the silicon steel metal particles from a relatively bottom to a relatively top, layer by layer, to form a silicon steel metal layer; and
S2 feeding treatment gas into the additive manufacturing printing apparatus, and performing laser scanning on the silicon steel metal particles again to enable the treatment gas to react with molten silicon steel metal particles, to form an insulting nitride layer; and
alternately performing the S1 and S2 to form the laminated iron core of a structure having a plurality of alternate silicon steel metal layers and insulating nitride layers.

10. The method of claim 2, wherein a thickness of the insulating nitride layer ranges from 20 microns to 40 microns.

11. The method of claim 2, wherein a ratio of the inert gas to the treatment gas ranges from 2 to 5.

12. The method of claim 2, further comprising:
conveying the silicon steel metal particles from a forming cylinder of the additive manufacturing printing apparatus into a recycling cylinder for recycling.

13. The method of claim 2, wherein the additive manufacturing printing apparatus is a selective laser melting device.
